(19) United States
(12) Patent Application Publication
(10) Pub. No.: US 2026/0145475 A1
(43) Pub. Date: May 28, 2026

(54) TORSION BAR BEARING COMPRISING A RADIAL ABUTMENT

(71) Applicant: Sumitomo Riko Company Limited, Aichi-ken (JP)

(72) Inventors: Valeri BECKER, Freiensteinau (DE); Artur KERBS, Hungen (DE); Christian MÜLLER, Schlüchtern (DE)

(21) Appl. No.: 19/399,934

(22) Filed: Nov. 25, 2025

(30) Foreign Application Priority Data
Nov. 27, 2024 (DE) 10 2024 135 065.2
Nov. 10, 2025 (DE) 20 2025 106 859.1

(51) Int. Cl. B60G 11/20; B60G 21/00

(52) U.S. Cl. CPC B60G 11/20; B60G 21/005; B60G 2204/1222; B60G 2204/418; B60G 2204/43; B60G 2206/73; B60G 2206/821

(57) ABSTRACT

A torsion bar bearing is disclosed for arranging a torsion bar having a cylinder axis (Z) on a vehicle portion. The torsion bar bearing includes a bearing portion which at least partially surrounds the torsion bar, and a bracket which holds the bearing portion on the vehicle portion. Aa torsion bar movement tolerance portion is provided which is configured to allow a torsional movement of the torsion bar but is relatively rigid with respect to a translational movement of the torsion bar relative to the vehicle portion. The torsion bar movement tolerance portion comprises a torsion tolerance geometry which enables a torsional movement of the torsion bar.

### FIELD

The disclosure relates to a torsion bar bearing for arranging a torsion bar on a vehicle portion, comprising: a bearing portion which at least partially surrounds the torsion bar; and a bracket which holds the bearing portion on the vehicle portion.

### BACKGROUND

Torsion bar bearings, which can also be referred to as stabilizer bushings, are used in motor vehicles to improve the cornering stability of a vehicle. When cornering, which is to be adjusted via a steering system of a vehicle, one of the wheels tends to reduce or even lose its contact with the ground. This rolling can be reduced or even prevented by a co-operation between the torsion bar and a torsion bar bearing or stabilizer bushing, wherein the torsion bar bearing can hold the torsion bar spatially fixed in relation to a vehicle portion, i.e. such that it prevents a translational movement, while a torsional movement of the torsion bar can absorb any rolling, in particular when cornering.

EP 3 530 500 A1 discloses a torsion bar bearing which prevents a translational movement of the torsion bar in relation to the vehicle body when cornering, but unfortunately also allows little or no torsion of the torsion bar. The torsion bar itself must then serve to absorb the torsional movement, which can lead to increased stress on the mechanical components when cornering.

JP 6368728 B2 likewise discloses a torsion bar bearing which holds the torsion bar in the radial direction with respect to the vehicle body, but again enables little torsion without mechanically stressing the torsion bar in its free region which is not held, i.e. a translational movement of the torsion bar is prevented, without allowing any torsional movement.

WO 2007/126359 A1 proposes a bracket of a torsion bar on a vehicle body, in which two different bearing portions are provided. The torsion bar itself is then formed to be purely cylindrical on the one hand and provided at another point with a constriction which corresponds to a corresponding bulge on the bearing portion, and a translationally hard or rigid mounting is provided which is advantageous in this way. In the event of torsional movements of the torsion bar, however, little additional free space can be enabled within the bearing.

JP 2012-162171 A also discloses a corresponding torsion bar bearing which shows the same properties as the prior art otherwise discussed above, i.e. the mounting undesirably has an high torsional rigidity in addition to a desirable translational rigidity.

Common to all the prior art cited is therefore that a high degree of rigidity in the radial direction is provided on the one hand, in order to minimize a translational movement of the torsion bar relative to the vehicle portion, and a disadvantageously high degree of rigidity in the torsion bar bearing, which does not tolerate rolling, in the event of torsional movements must likewise be reckoned with on the other hand.

An improved torsion bar bearing is to be provided in accordance with the instant disclosure.

### SUMMARY

In an embodiment, a torsion bar bearing for arranging a torsion bar having a cylinder axis (Z) on a vehicle portion. The torsion bar bearing comprises a bearing portion which at least partially surrounds the torsion bar and a bracket which holds the bearing portion on the vehicle portion. The torsion bar bearing also comprises a torsion bar movement tolerance portion which is configured to allow a torsional movement of the torsion bar (12) and is configured to inhibit translational movement of the torsion bar relative to the vehicle portion. The torsion bar movement tolerance portion comprises a torsion tolerance geometry which enables a torsional movement of the torsion bar.

In an embodiment, the torsion bar bearing comprises a torsion bar movement tolerance portion which is configured to allow a torsional movement of the torsion bar, but is relatively rigid with respect to a translational movement of the torsion bar in relation to the vehicle body, wherein the torsion bar movement tolerance portion comprises a torsion tolerance geometry which absorbs a torsional movement of the torsion bar.

This means that the torsion bar allows the torsion bar to absorb a torsional distortion while a radial movement of the torsion bar in relation to the vehicle body is reduced, thus enabling any rolling by a vehicle to be reduced.

The torsion tolerance geometry then advantageously provides at least one free space which extends in portions and/or over a partial circumference around the cylinder axis of the torsion bar, i.e. torsion in the torsion bar can be compensated for within the free space, while a translational movement of the torsion bar is simultaneously reduced or even prevented by abutments. In this case, the torsion bar itself can be relieved of torsion, and the contact with the ground of the wheels of a vehicle can be intensified. This mitigates against rolling.

It is less important to arrange one or more free spaces at particular points between a region assigned to the torsion bar and a region assigned to the bracket, wherein abutments which act in the translational direction are accommodated at said points such that they can move in a torsional direction. It is more essential that the free spaces together with the abutments respectively assigned to them, which have a limiting effect in the translational direction, impart a torsional freedom to the region of the torsion bar bearing which is assigned to the torsion bar, wherein the pattern of the free spaces (and the abutments which are respectively assigned to them and act in the translational direction) around the torsion bar is to a certain extent arbitrary. These free spaces and abutments can be provided uniformly or non-uniformly over the circumference of the torsion bar or, in order for example to take account of particular stresses acting on the torsion bar, provided in greater numbers in the lower region of the torsion bar bearing. The arrangement can also be triangular, rectangular, etc. in cross-section.

The torsion bar is advantageously assigned at least one translational movement limiting part which can advantageously be formed as an abutment within the torsion bar bearing or on the torsion bar itself.

In accordance with one variant, the bearing portion can advantageously be connected, for example glued, to the torsion bar, wherein the free space is provided in the bracket of the torsion bar bearing, i.e. in a holding clamp. The bracket or holding clamp fixes the torsion bar bearing on the vehicle itself, wherein the translational movement limiting part (for example, an abutment) can be arranged on an outer circumference of the bearing portion which faces the holding clamp, or vice versa.

The free space(s) is/are provided on or in the bearing portion, while the translational movement limiting part(s) can be established on the torsion bar or on a component part which is connected, for example glued, to it. Advantageously, the torsion bar bearing comprises a damping portion, for example a damping casing, which is formed from a damping material and interposed between the torsion bar and the bracket, for example a clamp. Rubber or a plastic can then be used. A corresponding damping portion or damping casing can also consist of multiple layers which are intermediately mounted at different radial distances around the torsion bar and therefore between the torsion bar and the bracket, for example a clamp.

It is shown in relation to the embodiments that by providing a free space for the torsion bar which acts in the torsional direction, a torsional movement of the torsion bar can be completely or partially compensated for, while the overall design of the torsion bar bearing significantly reduces or even prevents a translational movement of the torsion bar, i.e. a movement of the torsion bar outwards, inwards and/or upwards or downwards from the vehicle body.

Another embodiment replaces the aforementioned free space along with the abutment with the hardness of a bearing casing, in particular a rubber casing, which is connected and in particular glued to the torsion bar. This rubber casing is optionally blocked radially and at any rate blocked axially with respect to the torsion bar, i.e. the material of the rubber casing cannot yield or flow, at least in the axial direction. The desirable torsional movement therefore occurs in the material of the rubber casing, while the material is blocked from yielding in the axial direction of the torsion bar, thus providing the desirable rigidity with respect to translational movements and combining it with the very advantageous torsional freedom. The rubber casing therefore provides the free space which enables a torsional movement, while the at least axial encapsulation of the material of the rubber casing blocks the advantageous radial rigidity by axially and as applicable radially blocking a yielding movement of the rubber material of the rubber casing which is connected to the torsion bar.

A TPE material could also be used in combination with rubber or even separately instead of rubber.

The embodiments are explained in more detail below by referring to the accompanying figures, wherein identical reference numerals denote identical or at least functionally identical component parts of the torsion bar bearing.

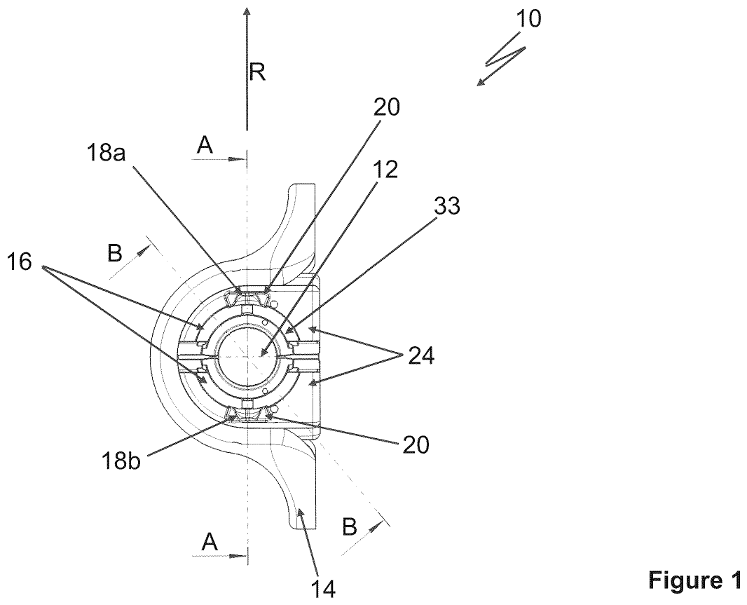

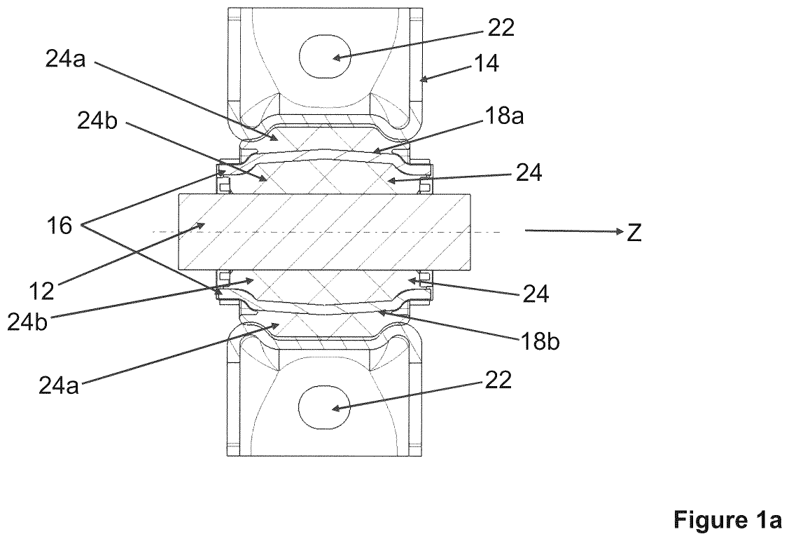

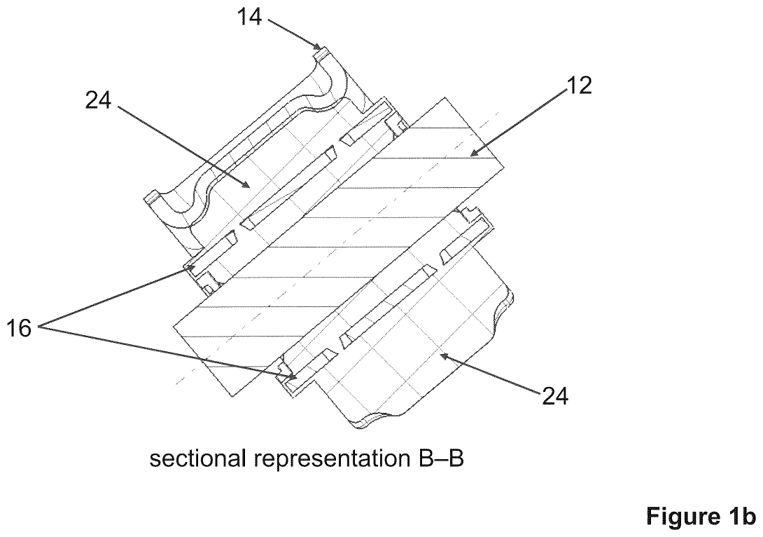

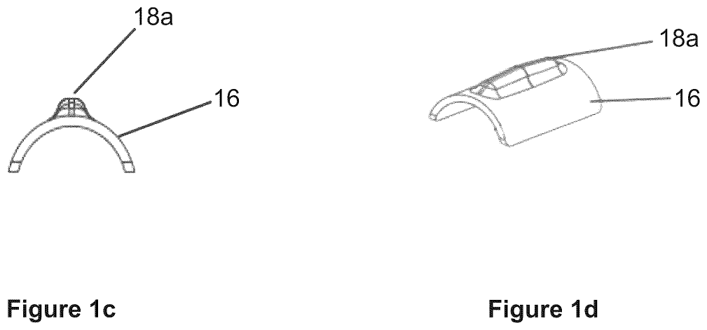

DRAWING DESCRIPTION FIG. 1 shows an embodiment of a torsion bar bearing in accordance with an embodiment, in which a radial abutment is provided in a half-shell, i.e. the torsion tolerance geometry is formed in the half-shell which surrounds the torsion bar (indicated in FIG. 1 as a short rod), wherein the representation shows a front view.

FIG. 1a shows a cross-section through the embodiment in accordance with FIG. 1 in

the direction of the cylinder axis of a torsion bar shown in FIG. 1a, along the sectional plane A- A in accordance with FIG. 1.

FIG. 1b shows a cross-section, offset in the rotational direction, through the front view in accordance with FIG. 1 along the sectional plane B-B, with a torsion bar installed.

FIGS. 1c and 1d show a front view and a perspective view of a half-shell such as is used in accordance with the first embodiment.

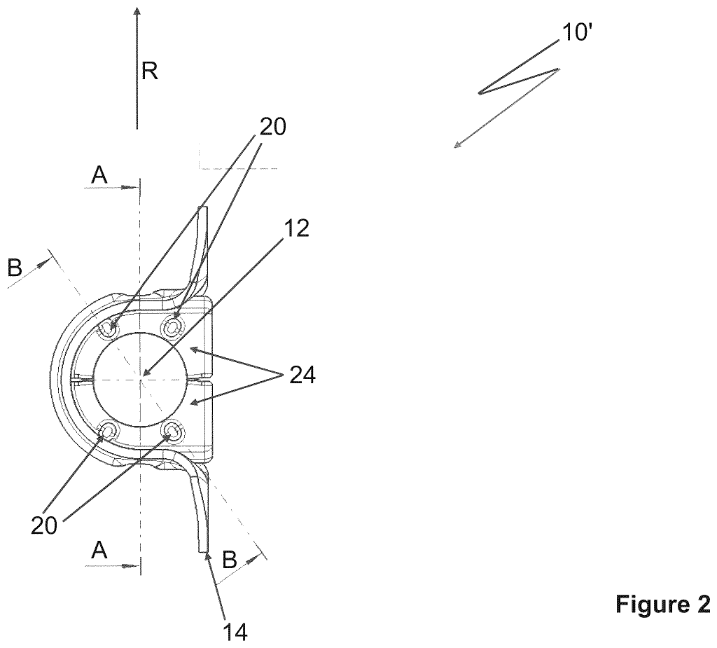

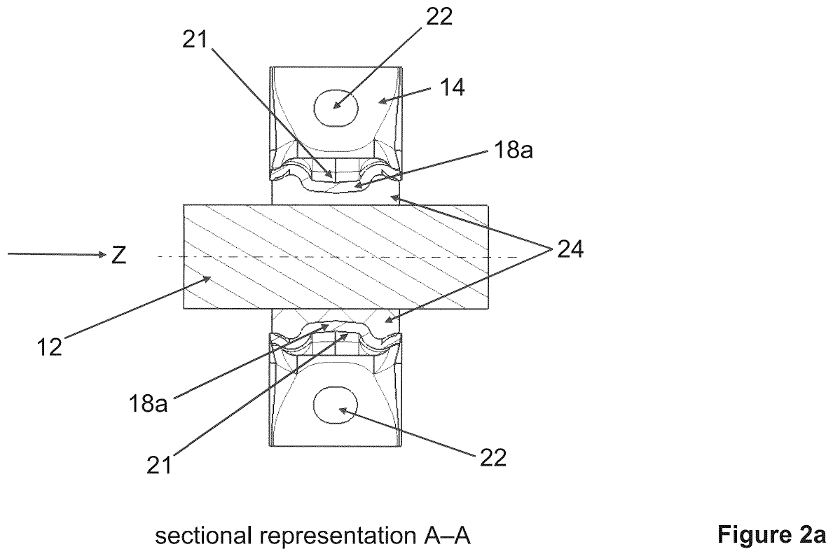

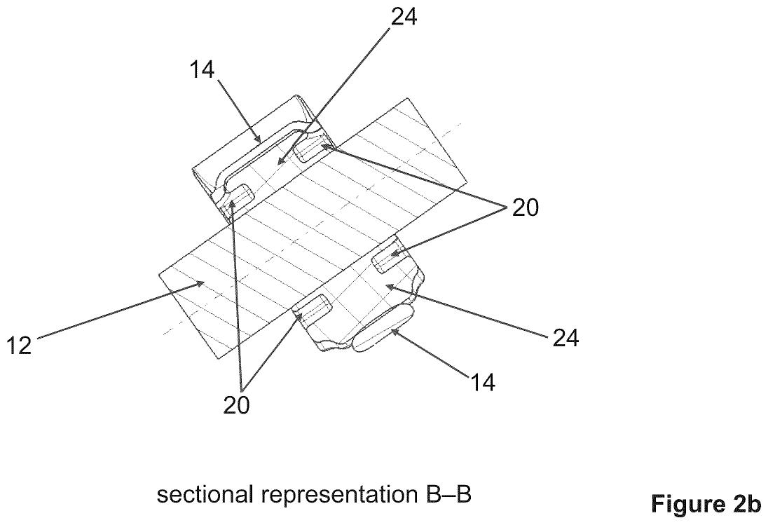

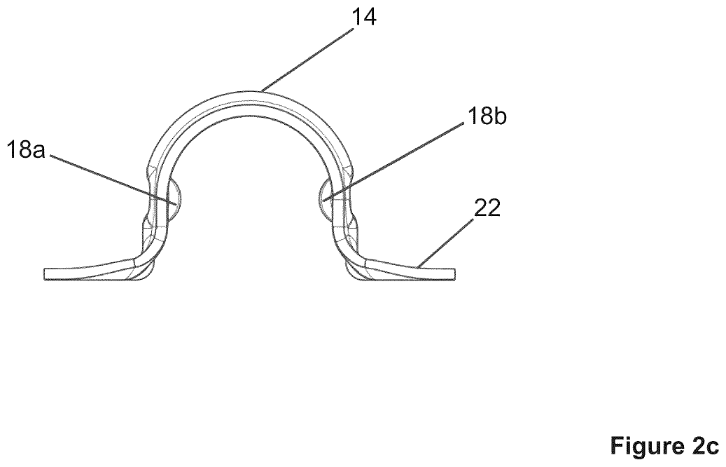

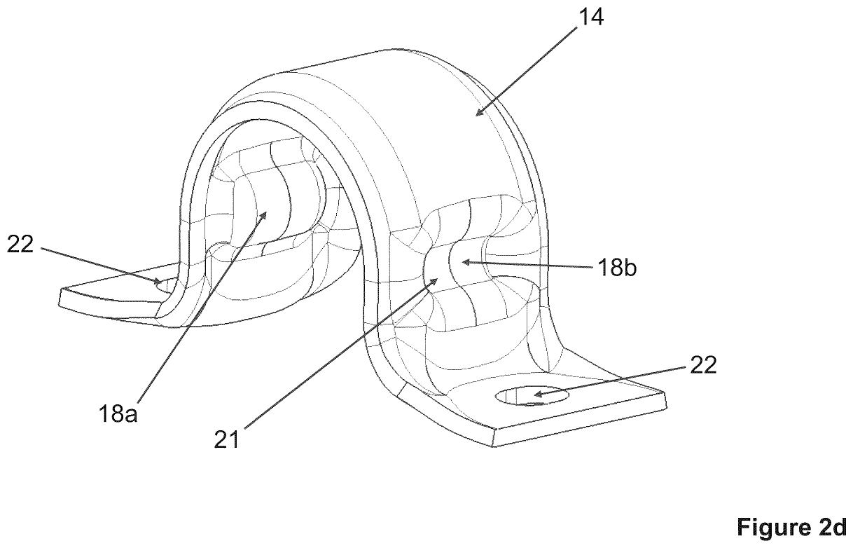

FIG. 2 shows another embodiment in a front view, with a torsion bar.

FIGS. 2a and 2b show cross-sections, offset with respect to each other in the rotational direction, along the sectional planes A-A and B-B in accordance with FIG. 2, wherein a radial abutment is then provided in a clamp, and each with a torsion bar.

FIGS. 2c and 2d show a front view and a perspective view of a clamp in accordance with the second embodiment.

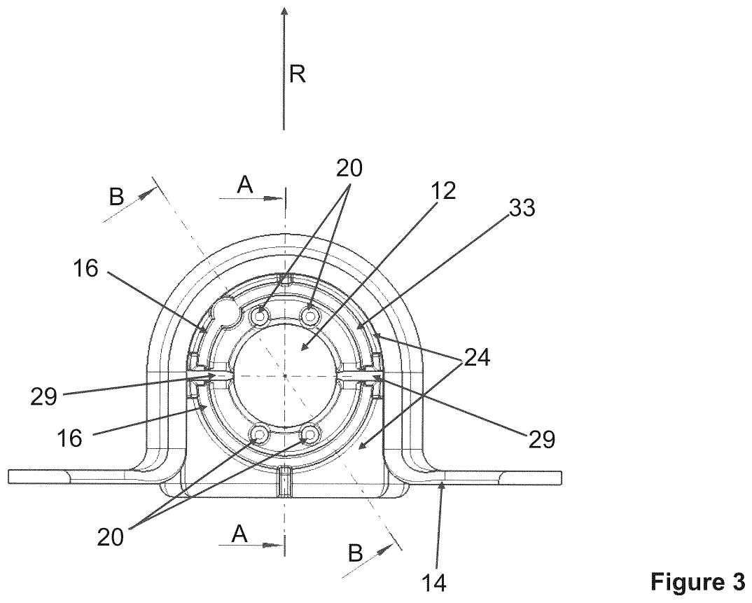

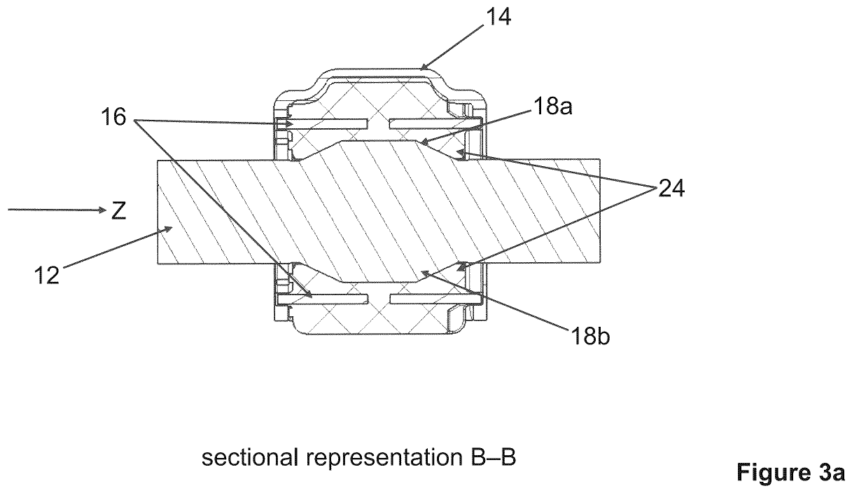

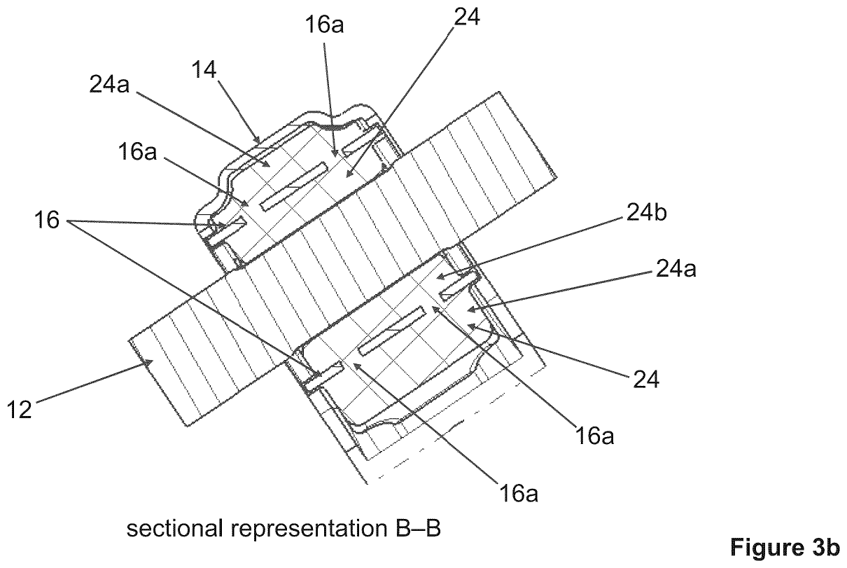

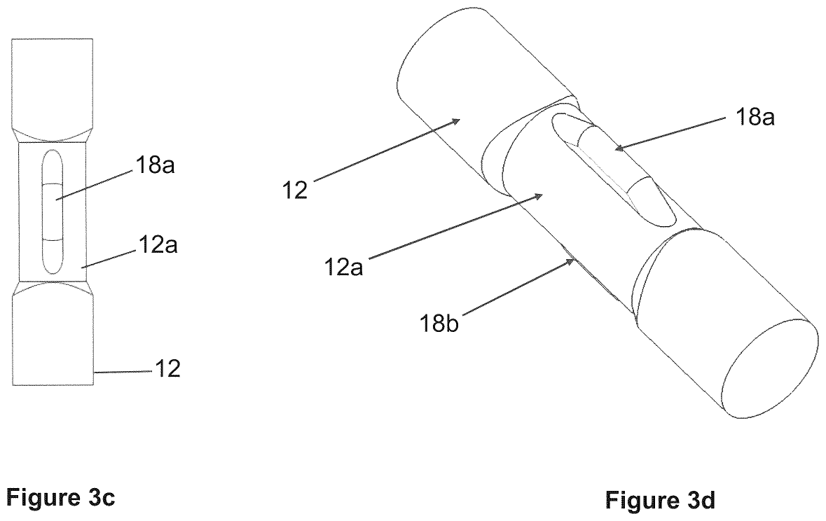

FIG. 3 shows an additional embodiment in a front view, wherein a radial abutment is incorporated into a torsion bar.

FIG. 3a shows a longitudinal section through the representation in accordance with

FIG. 3 in the sectional plane A-A, with a torsion bar arranged.

FIG. 3b shows a longitudinal section through the embodiment in accordance with FIG. 3 through the sectional plane B-B, with a torsion bar arranged.

FIGS. 3c and 3d show the torsion bar in accordance with this third embodiment in a plan view and in a perspective view.

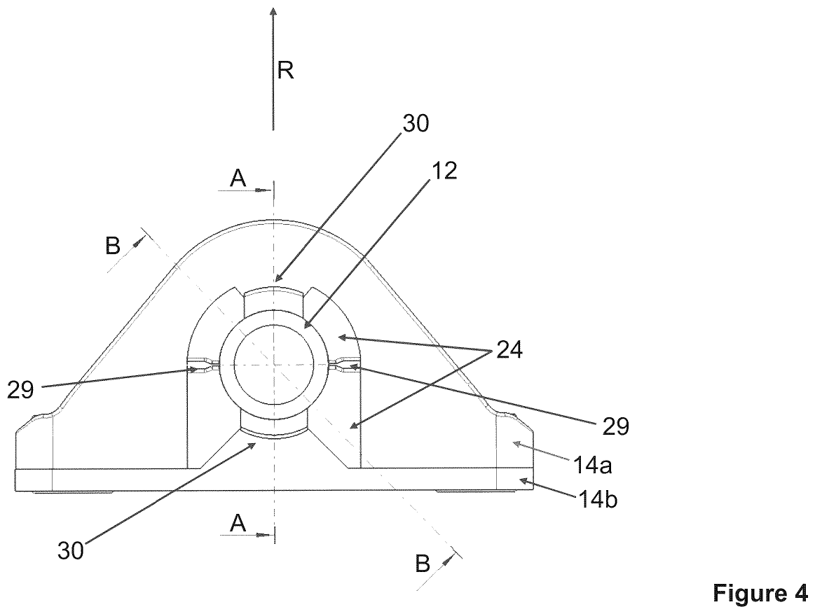

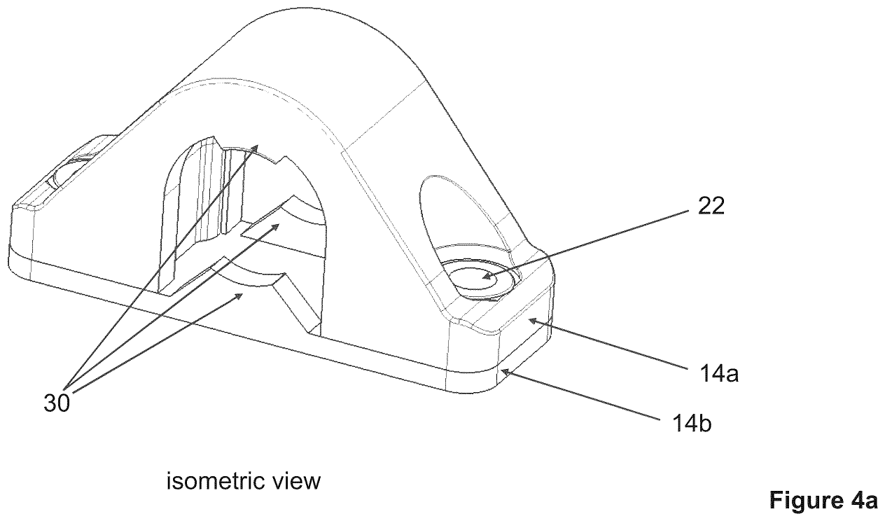

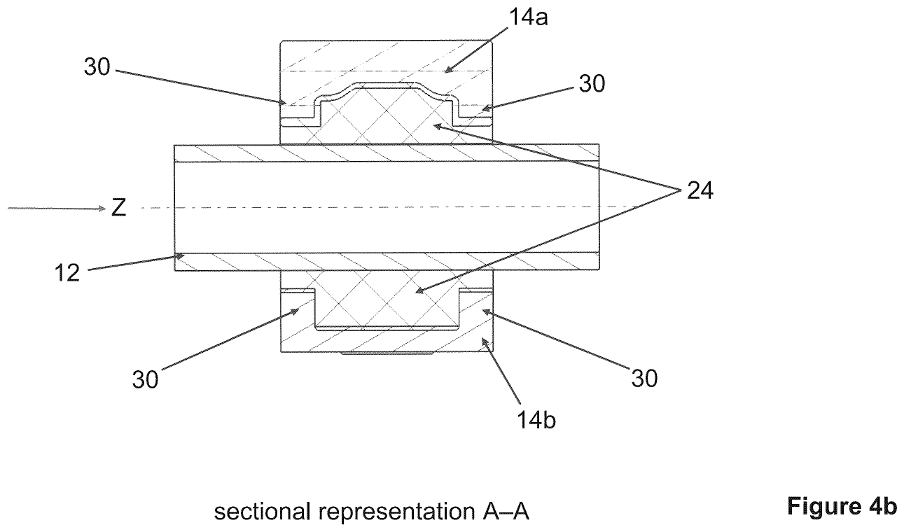

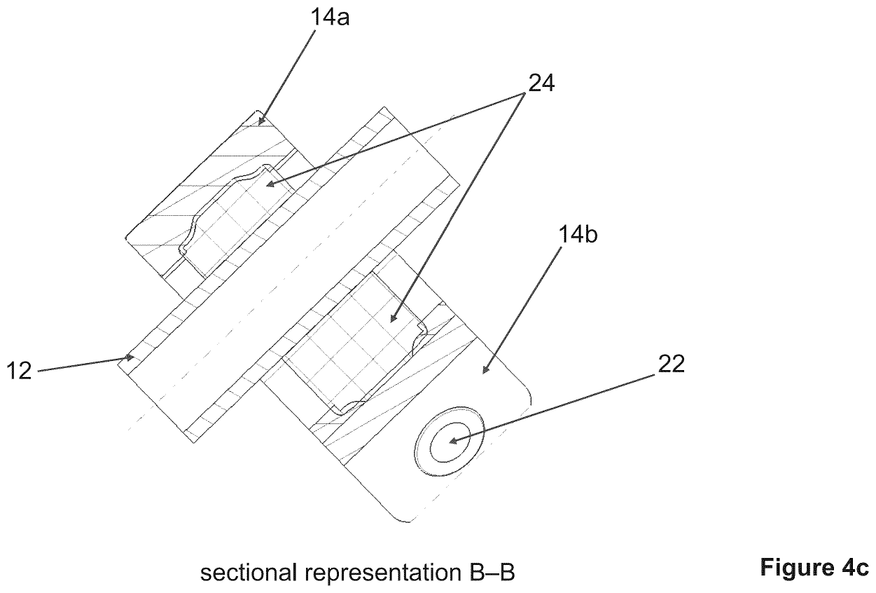

FIGS. 4 to 4c show a fourth embodiment, in which a radial abutment is provided on the outside of a clamp. FIG. 4 shows a front view, with the torsion bar indicated as a short rod.

FIG. 4a shows a perspective view of the embodiment in accordance with FIG. 4, without the torsion bar or the torsion bar bearing.

FIGS. 4b and 4c show longitudinal sections along the cylinder axis Z through the embodiment in accordance with FIG. 4 along the sectional planes A-A and B-B, with a torsion bar arranged.

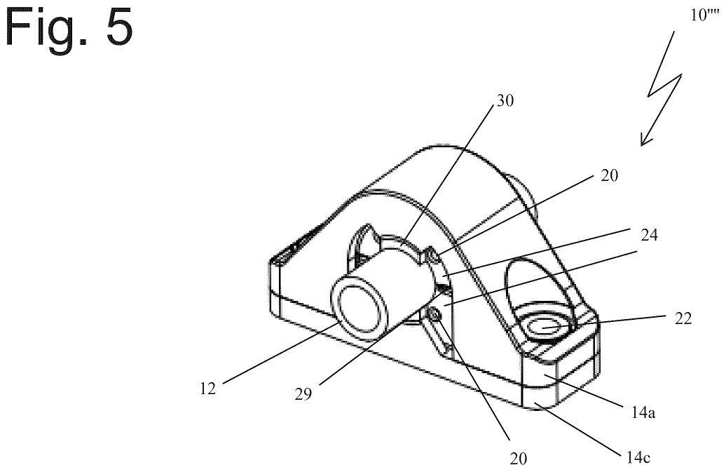

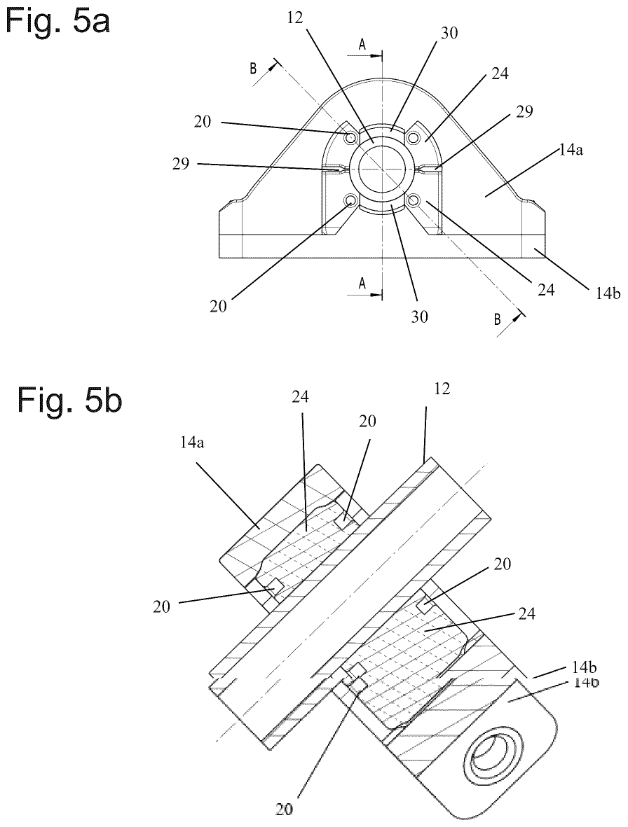

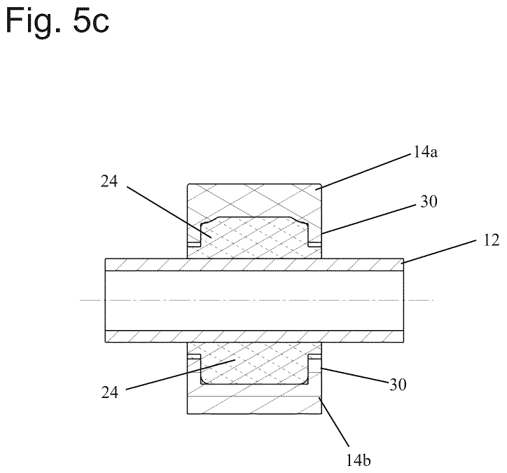

FIG. 5 corresponds to an embodiment showing a variant of the embodiment according to FIGS. 4 to 4c in an isometric top view.

FIG. 5a shows a side view of the embodiment according to FIG. 5 in the direction of the cylinder axis of the torsion bar.

FIG. 5b shows a section B-B through the embodiment shown in FIG. 5a.

FIG. 5c shows a section A-A through the embodiment shown in FIG. 5a.

### DETAILED DESCRIPTION

In general terms, it can be disclosed by referring to all of the embodiments discussed below that the Shore hardness of the rubber material or TPE plastic material which is to be used can be in the range of 42 to 65 ShA for bearing component parts and damping component parts. Brackets, clamps and housings can be made of metal or a harder plastic.

The figures show the component parts of embodiments when not press-fitted, i.e. not calibrated, wherein overlaps are shown which are partially production-related and disappear when the component parts are installed. A torsion bar bearing will therefore as applicable comprise a greater volume of permanently elastic material than is available to it when installed, i.e. the permanently elastic material is compressed by installing the component part, since the installation space for a bracket or clamp for the torsion bar bearing in the embodiments is smaller than the torsion bar bearing itself when not installed.

For the sake of clarity, a torsion bar 12 is shown only as a portion in each of the figures. This local portion is the region of the torsion bar 12 which also interacts with the torsion bar bearing.

FIG. 1 shows a torsion bar bearing in accordance with an embodiment which is indicated in general terms by the reference sign 10. The torsion bar bearing 10, also called a stabilizer bushing, comprises a torsion bar 12 which is surrounded by a damping casing 24. The damping casing 24 can be formed from a permanently elastic material, for example rubber, TPE or the like, in order to absorb vibrations and therefore damp and suppress noise. Two half-shells 16 which are integrated into the damping casing 24 comprise respective abutments 18a and 18b which prevent a translation of the torsion bar 12 in the direction R (which points upwards in FIG. 1). The abutments 18a and 18b are accommodated in torsion tolerance geometries 20 which are then formed as free spaces. A clamp 14 which is arranged around the outside of the damping casing 24 holds the torsion bar bearing 10 on a vehicle body (not shown), for example via bolts, for example stud bolts.

The free space or spaces 20 can also be formed in the damping casing in addition to the abutments, as long as a desirable functional relationship is provided. The latter exists between the translational limiting function performed by the abutments 18a, 18b and the torsional freedom of movement of the torsion bar which is to be absorbed by the free spaces 20 and which is not or only partially absorbed by the material of the damping casing 24.

The damping casing 24 is rigidly connected, for example glued, to the torsion bar such that relative movements between the two components are not possible, while the free spaces 20 enable torsion within them, wherein the abutments 18a, 18b define the rotational movement free space in the direction of a rotational movement.

FIG. 1a shows a longitudinal section through the embodiment of a torsion bar bearing 10 in an embodiment, in accordance with FIG. 1, through the sectional plane A-A. The clamp 14 is held on a vehicle body (not shown) via fastening holes 22 through which bolts, for example stud bolts (not shown), are guided.

In FIGS. 1 to 1b, the torsion bar 12 is typically connected, for example glued and/or bolted, to the damping casing 24 and the half shells 16.

It may also be noted in relation to FIG. 1a that the fastening holes 22 are shown only because the component parts of the clamp 14 which comprise the fastening holes 22 are shown in a plan view.

The sectional representation arranged in the longitudinal direction of the torsion bar 12, i.e. along the cylinder axis Z of the torsion bar 12, shows both the half-shells 16 and the abutments 18a, 18b which are accommodated in the torsion tolerance geometries 20 in such a way as to enable a torsional movement.

The half-shells 16 sub-divide the damping casing 24 in such a way that two spring regions 24a and 24b are produced from the damping casing 24 in the present case, which provide the desirable translational rigidity and torsional freedom. In this way, the torsion bar movement tolerance portion 20 inhibits (prevents or substantially prevents) translational movement of the torsion bar 12. These bearing properties can be set by the thickness of the two spring regions 24a, 24b and the choice of material.

In all of the figures, references to axial directions refer to the axis Z and references to a radial direction refer to the direction pointing outwards from the torsion bar 12 along the arrow R in FIG. 1.

Respective side boundaries hold the component parts of the torsion bar bearing 10 in an embodiment together, spatially fixed in the direction of the cylinder axis Z of the torsion bar 12.

FIGS. 1c and 1d show a half-shell 16 such as is used in accordance with FIG. 1 to 1b. An abutment 18 a on the half-shell 16 is shown in both the front view in accordance with FIG. 1c and the perspective view in accordance with FIG. 1d.

The front view in accordance with FIG. 2 shows another embodiment of a torsion bar bearing 10′ in accordance with an embodiment.

The torsion bar bearing 10′ comprises a free space which is to be assigned to a torsion bar portion 12. In its end position, the torsion bar portion 12 is connected or glued to a damping casing 24 which can then be composed of two halves. The halves of the damping casing 24 are provided with free spaces 20. The abutments 18a support the torsion bar 12 in the translational direction and impart a high degree of rigidity in the radial direction R to the torsion bar 12, i.e. the torsion bar 12 can hardly yield or cannot yield at all in the direction R when in operation, which provides a high degree of rigidity with respect to translational movements of the torsion bar 12. Cylindrical free spaces 20 are indicated schematically. Abutments 18a are then provided by means of a bead 21 in the clamp 14, which is shown in FIGS. 2a and 2d.

The free spaces 20 co-operate with the abutments which are formed as beads 21 (see FIGS. 2a and 2d) in the clamp 14 in accordance with FIG. 2a which shows a section A-A through the embodiment in accordance with FIG. 2.

The damping casing 24 is glued onto or otherwise fixedly connected to the torsion bar portion 12 in accordance with FIG. 2a. The abutments 18a co-operate to provide a torsional freedom which enables the torsion bar portion 12 to be provided with a freedom of movement in the torsional direction.

The section B-B in accordance with FIG. 2b, the position of which has been indicated in FIG. 2, likewise shows the torsion bar 12 which is fixedly connected to the damping casing 24. The clamp 14 is likewise shown, namely in a perspective view in the upper region of FIG. 2b.

FIG. 2c shows the abutments 18a, 18b of the clamp 14 again in a perspective view. The overall torsion bar mounting 10′can be fastened to a vehicle via fastening holes 22 in the clamp 14, in order to hold the torsion bar (not shown in FIG. 2c) translationally rigid and capable of a torsional movement.

FIG. 2d shows the clamp 14 in a perspective representation, wherein the abutments 18a, 18b have again been schematically indicated in a perspective view.

Another embodiment of a torsion bar bearing 10″ is shown in a front view in FIG. 3.

In this embodiment, a torsion bar 12 is also held rotationally fixed in the direction R when in operation, but can perform a torsional movement to a certain extent.

In the plan view in accordance with FIG. 3, free spaces 20 are shown which extend around the torsion bar 12. The free spaces 20 are molded into a material, preferably rubber, together with the torsion bar 12, wherein the free spaces 20 are assigned respective abutments 18a, 18b which can be formed as appendages 18a and 18b of the torsion bar 12.

As shown in FIG. 3a, which is a section A-A in accordance with FIG. 3, the torsion bar 12 comprises abutments 18a, 18b which co-operate with the assigned free spaces 20 and enable a torsional movement in the torsional direction of the torsion bar 12. The region 29 in accordance with FIG. 3 represents a production-related free space. A labelling cavity in which for example manufacturer's instructions, a date of manufacture or the like can be provided can also contain extra material. The free space 29 is reduced or even completely disappears when the component part is installed and thereby calibrated.

The free spaces 20 are arranged such that they are separated by material of the damping casing 24 (see FIG. 3b) in relation to the abutments 18a, 18b, but have a function relationship to each other, i.e. torsion in the torsion bar can be absorbed by the free spaces, while the abutments 18a, 18b prevent translational movements.

FIG. 3b shows a section B-B in accordance with FIG. 3, wherein the torsion bar 12 shows a recess in this view. The torsion bar 12 can be supported in this region by a bearing. The position of the half-shells 16 is likewise shown and provides a partial decoupling, in order to in turn provide two spring regions 24a, 24b for the damping casing 24 which are to provide the desirable radial rigidity and the torsional freedom. The spring region 24b of the damping casing 24 is preferably glued or otherwise mechanically fixed to the torsion bar 12.

FIG. 3c shows how the torsion bar 12 is formed in the embodiment 10″ of the torsion bar bearing in accordance with an embodiment. The torsion bar 12 comprises a constriction 12a having an abutment 18a which is part of the torsion bar 12. The constriction 12a is filled with the damping casing 24 in the finished torsion bar bearing 10″. FIG. 3d shows the torsion bar 12 again in a perspective representation.

FIG. 4 shows another embodiment of a torsion bar bearing 10′″, wherein a torsion bar 12 is schematically shown which is surrounded by a damping casing 24 which preferably functionally represents a rubber spring. The damping casing 24 is connected, in particular glued, to the torsion bar 12. In accordance with the embodiment according to FIG. 4, the clamp 14 is realized as an upper bracket by an upper clamp 14a and as a lower bracket by a lower clamp 14b.

The clamp 14 typically comprises an upper clamp 14a and a lower clamp 14b which can be assembled, for example latched or glued to each other.

The damping casing 24 can be formed from a rubber material or a TPE material. Axial blocking portions 30 which are provided at the ends of the clamp 14 in the direction of the cylinder axis Z of the torsion bar 12 prevent the material of the damping casing 24 from yielding axially. The resultant balance of forces can therefore allow a torsional movement, while preventing the torsion bar 12 from rotating outwards (and also inwards) in the radial direction R.

The axial blocking portion 30 is shown again, more clearly and separately, in the perspective representation in accordance with FIG. 4a. In this embodiment, the clamp 14 is formed such that it does not radially block the damping casing 24 in accordance with FIG. 4. Supplementarily, however, it can also be expedient to radially block the damping casing 24, wherein the clamp 14 and the axial blocking portions 30 would then form a tighter boundary around the damping casing 24.

FIG. 4b again shows the damping casing 24 in a section A-A in accordance with FIG. 4, wherein the blocking portions 30 are shown at the respective ends of the clamp 14. In FIGS. 4 and 4c, the hatchings overlap in an region between the damping casing 24 and the clamp 14. The rubber which is preferred used is to be biased in this region.

FIG. 4c shows a section B-B in accordance with FIG. 4, which again shows how the damping casing 24 is then formed around the torsion bar 12.

The torsional movement occurs in the damping casing 24 which preferably consists of rubber, wherein the hardness of the rubber material is selected so as to achieve a relatively high degree of radial rigidity (in the direction R in accordance with FIG. 4), while torsion is enabled in the material of the damping casing 24. A material used for the bearing casing can in particular be selected to be soft in order to achieve a weak degree of torsional bearing rigidity. The high degree of radial bearing rigidity is achieved by the axial blocking portions 30. The hardness is preferably in a range of 42 to 65 ShA.

The embodiment 10″″ according to FIG. 5 preferably corresponds to a variant of the embodiment according to FIG. 4.

In an isometric view of the components shown in FIGS. 4 to 4c, the embodiment 10″″ additionally shows free spaces 20 in the damping jacket 24.

These are arranged uniformly along the circumference of the torsion bar in the damping sleeve 24, as shown in FIG. 5. The damping sleeve 24, which consists of two sections, is assembled around the torsion bar 12, leaving a manufacturing-related clearance 29.

Here, too, axial blocking sections 30 restrict the damping sleeve 24 in the cylindrical-axial direction with respect to the torsion bar 12.

In addition to the material selection used in the embodiment shown in FIGS. 4 to 4c, and in addition to selecting the hardness of the damping or rubber sleeve 24, the spaces 20 are provided to create a torsional connection within the damping sleeve 24.

FIG. 5a shows a side view of the torsion bar bearing 10″″ according to FIG. 5. It can be seen that blocking sections 30 are arranged above and below the torsion bar 12, which in themselves help to prevent translational movements of the torsion bar 12. Four spaces 20 are provided symmetrically around the torsion bar 12 in the damping sleeve 24, allowing additional torsional movements of the torsion bar, which can be rigidly connected to the parts of the damping sleeve 24, for example, by bonding.

In FIG. 5b, which shows a section B-B through the embodiment according to FIG. 5 or through FIG. 5a, the position of the clearances 20 within the damping sleeve 24 around the outer circumference of the torsion bar 12 is shown in more detail. The material of the damping sleeve 24 can be selected such that its hardness and flexible properties already accommodate a torsional movement of the torsion bar relative to the torsion bar bearing itself. The additional clearances 20 can provide further torsional freedom of movement of the torsion bar relative to the bearing 14a, 14b.

FIG. 5c shows section A-A through the embodiment according to FIG. 5a, which essentially depicts the features already shown in FIG. 4b, since the embodiment according to FIGS. 4 to 4c is an embodiment upon which the embodiment according to FIGS. 5 to 5c is based.

According to the embodiment of FIGS. 5 to 5c, the clearances 20 in the axial direction of the torsion bar are not continuous through the damping shell 24. That is, depending on the thickness of the damping shell 24, they extend only 10 to 25% of the thickness of the damping shell 24 in the axial direction of the torsion bar 12 into the damping shell 24 in order to ensure the stability of the damping shell 24.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

10, 10′, 10″, 10′″, 10″″ torsion bar bearing
12 torsion bar, torsion bar portion
12a constriction in the torsion bar
14 bracket, clamp
14a upper bracket, upper clamp
14b lower bracket, lower clamp
16 half-shell
16a half-shell bore
18a, 18b translational movement limiting part, abutment
20 torsion bar movement tolerance portion, torsion tolerance geometry, free space
21 bead
22 fastening holes
24 damping casing
24a, 24b spring regions
29 production-related free space
30 axial blocking portion
33 shell
Z cylinder axis of the torsion bar
R radial direction with respect to the clamp

1. A torsion bar bearing for arranging a torsion bar having a cylinder axis (Z) on a vehicle portion, comprising:
a bearing portion which at least partially surrounds the torsion bar; and
a bracket which holds the bearing portion on the vehicle portion, and
a torsion bar movement tolerance portion which is configured to allow a torsional movement of the torsion bar and is configured to inhibit translational movement of the torsion bar relative to the vehicle portion, wherein the torsion bar movement tolerance portion comprises a torsion tolerance geometry which enables a torsional movement of the torsion bar.

2. The torsion bar bearing according to claim 1, wherein the torsion bar movement tolerance portion comprises at least one free space which extends in portions and/or over a partial circumference around the cylinder axis (Z) of the torsion bar.

3. The torsion bar bearing according to claim 1, wherein at least one translational movement limiting part is assigned to the torsion bar.

4. The torsion bar bearing according to claim 2, wherein at least one translational movement limiting part is assigned to the torsion bar.

5. The torsion bar bearing according to claim 3, wherein the translational movement limiting part is provided in the free space and configured to be limiting for translational movements and to impart a torsional freedom of movement to the torsion bar.

6. The torsion bar bearing according to claim 1, wherein the bearing portion is formed as a damping casing, wherein the bracket comprises a portion which substantially blocks the damping casing at least in the axial direction (Z) in such a way that torsion is absorbed in a material of the damping casing, but the translational movement of the torsion bar can be substantially prevented.

7. The torsion bar bearing according to claim 6, wherein the damping casing is fixedly connected, for example glued, to the torsion bar, wherein the bracket comprises at least one translational movement limiting part in a region facing the damping casing.

8. The torsion bar bearing according to claim 6, wherein the damping casing is at least partially interrupted by means of a shell, such that two spring regions are established, wherein the shell preferably consists of two half-shells.

9. The torsion bar bearing according to claim 6, wherein at least one damping casing is provided between the torsion bar and the bracket.

10. The torsion bar bearing according to claim 7 wherein the damping casing is at least partially interrupted by means of a shell, such that two spring regions are established, wherein the shell preferably consists of two half-shells.

11. The torsion bar bearing according to claim 6, wherein the bracket comprises an axial blocking portion which blocks the material (preferably rubber or a TPE material) of the damping casing from yielding in the axial direction (Z).

12. The torsion bar bearing according to claim 6 wherein the bracket blocks the damping casing in the radial direction (R).

13. The torsion bar bearing according to claim 11 wherein the bracket blocks the damping casing in the radial direction (R).

14. The torsion bar bearing according to claim 6 wherein the damping casing comprises at least one free space around the outer circumference of the torsion bar, which can preferably also absorb a torsional movement of the torsion bar.

15. The torsion bar bearing according to claim 11 wherein the damping casing comprises at least one free space around the outer circumference of the torsion bar, which can preferably also absorb a torsional movement of the torsion bar.

16. The torsion bar bearing according to claim 12 wherein the damping casing comprises at least one free space around the outer circumference of the torsion bar, which can preferably also absorb a torsional movement of the torsion bar.

17. The torsion bar bearing according to claim 14, wherein the free space or spaces is/are non-continuous in the axial direction of the cylinder axis of the torsion bar.

18. The torsion bar bearing according to claim 15 wherein the free space or spaces is/are non-continuous in the axial direction of the cylinder axis of the torsion bar.

19. The torsion bar bearing according to claim 16 wherein the free space or spaces is/are non-continuous in the axial direction of the cylinder axis of the torsion bar.

20. The torsion bar bearing according to claim 1, wherein the torsion bar movement tolerance portion is relatively rigid with respect to translation movement of the torsion bar relative to the vehicle portion.
